(19) United States
(12) Patent Application Publication
(10) Pub. No.: US 2010/0130666 A1
(43) Pub. Date: May 27, 2010

(54) Particulate Glass Compositions and Methods of Production

(75) Inventors: Jarrod R. Hart, Cornwall (GB); Jeremy Hooper, Cornwall (GB); David Robert Skuse, Cornwall (GB); Scott K. Palm, Alpharetta, GA (US); Daniel Tsai, Alpharetta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Minerals Limited, Cornwall (GB)

(21) Appl. No.: 11/720,758

(22) PCT Filed: Jul. 21, 2006
(86) PCT No.: PCT/GB2006/002742

§ 371 Date: Feb. 5, 2010

(30) Foreign Application Priority Data
Jul. 22, 2005 (GB) 0515088.3
May 5, 2006 (GB) 0608938.7

(51) Int. Cl. C03C 4/00; C03C 12/00; C08K 3/40; B02C 23/18; B02C 19/00; B32B 27/20

(52) U.S. Cl. 524/494; 428/402; 106/489; 241/15; 241/22; 241/24.1; 241/24.3

(57) ABSTRACT

There is disclosed a composition comprising a fine particulate glass cullet. The particulate material may be obtained by a suitable grinding process. The particulate cullet is useful as an inexpensive filler for polymer compositions and in abrasive compositions.

The present invention relates to particulate glass cullet, to methods of production thereof, uses of the particulate material, for example as fillers or pigments, and to compositions including the same.

### BACKGROUND OF THE INVENTION

It is well known to incorporate particulate inorganic materials, such as ground inorganic minerals into polymer compositions for a variety of purposes. One widespread use of such particulate materials is as a reinforcing or functional filler for a polymer composition; the filler may provide the polymer composition with a variety of properties, including for example abrasion resistance, and electrical resistance. In addition, the filler may impart various desirable optical properties to the composition, such as colour and brightness, and in such circumstances is referred to in the art as a pigment. Particulate materials may also be added to impart other properties to the polymer composition. For example, natural silica and talc are commonly added as antiblocking agents to polymer compositions which are to be formed into polymer film. Polymer compositions such as sealants, mastics, adhesives and the like, all also require the addition of particulate additives to adjust and improve their properties.

Inorganic particulate materials can also be incorporated into paints and varnishes, coatings, such as automotive clear coats and gel coats, and cosmetic and pharmaceutical preparations. These particulate materials are also useful as rheology modifiers in polymer compositions, and in dental compositions for the purpose of improving abrasion resistance.

Certain hard inorganic materials in particulate form, such as quartz, also find use as abrasive particles in abrasive compositions and articles.

One important factor in the production of compositions and articles which incorporate a particulate material is the cost of the particulate material. Whilst inexpensive filler materials are available, it would be desirable to provide further inexpensive particulate materials having desirable properties across a variety of end uses.

Glass which has been finely ground is known for a variety of speciality end uses, for example as a bioactive material which may be used in bone regeneration, and in dental uses. Typical starting materials for the production of such particulate glasses are high purity materials such as high silica porous glass (U.S. Pat. No. 4,052,010) and borosilicate glass (U.S. Pat. No. 4,547,531 and U.S. Pat. No. 5,340,776). Such high purity materials are expensive to produce and are not practical materials for production in the high volumes which are required of industrial particulate materials to be used as bulk filler and pigments in polymer compositions.

The present inventors have surprisingly found that a glass cullet may be ground using grinding procedures to obtain a particulate material which has a number of desirable optical and physical properties which enable its use as a filler or pigment in a variety of polymer compositions

Thus the present invention provides an economical route to a particulate glass with desirable properties, making use of an inexpensive starting material, and which is processed using grinding technology.

### SUMMARY OF THE INVENTION

According to an aspect of the present invention, there is provided a particulate glass cullet having a d₅₀ of less than 7 μm and a brightness greater than 80%.

According to another product aspect of the present invention, there is provided a particulate glass cullet having a d₅₀ less than 4 μm and a brightness greater than 80%.

According to yet another product aspect of the present invention, there is provided a particulate glass cullet having a d₅₀ less than 3 μm and a brightness greater than 80%.

The fine particulate material of the present invention has a high intrinsic brightness and may also have a low yellowness. These properties are surprising in view of the poor brightness and tint of the starting cullet material.

According to a process aspect of the present invention, there is provided a process for the preparation of particulate glass cullet which comprises grinding a glass cullet to a particle size distribution such that the d₅₀ is smaller than 7 μm, and recovering a product having a brightness greater than 80%.

According to another process aspect of the present invention, there is provided a process for the preparation of particulate glass cullet which comprises grinding a glass cullet to a particle size distribution such that the d₅₀ is smaller than 3 μm, and recovering a product having a brightness greater than 80%.

According to a yet another process aspect of the present invention, there is provided a process for the preparation of particulate glass cullet which comprises grinding a coarse glass cullet to a particle size distribution such that the d₅₀ is smaller than 4 μm, and recovering a particulate product having a brightness greater than 80%.

As discussed in more detail below, it was not expected by the inventors that grinding a cullet to the degree of fineness specified above was possible.

The particulate glass cutlet of the invention may, for example, be used as a filler or pigment in a polymeric composition, as an antiblocking agent, or as an abrasive material. Also provided, therefore, in accordance with the present invention, are polymeric compositions which include the particulate cullet material of the invention, and articles produced from such compositions, such as polymer films.

The particulate material may also be used in paints and varnishes, coatings, such as clear coats as may be used in automotive applications; in cosmetics, pharmaceuticals and dental compositions; and as rheology modifiers.

### BRIEF DESCRIPTION OF THE DRAWINGS

FIG. 1 is an electron micrograph of a recycled clear container glass cullet which has been ground at an energy input of 350 kWh t⁻¹.

FIG. 2 is the same material as FIG. 1, but on a higher magnification.

FIGS. 3a to 3d are photographs of a plastic filled with the particulate glass cullet of the present invention and other commercially available fillers.

FIGS. 4a to 4j are microscope images showing the dispersion of the particulate cullet of the invention and other commercially available fillers in LLDPE masterbatch.

FIG. 5 is a chart showing the blocking force of 7 μm and 3 μm cullet samples compounded into LLDPE (Linear Low Density Polyethylene) masterbatch.

FIG. 6 is a chart showing the re-blocking force of 7 μm and 3 μm cullet samples compounded into LLDPE (Linear Low Density Polyethylene) masterbatch.

FIG. 7 is a chart showing the film-to-film coefficient of friction of 7 μm and 3 μm cullet samples compounded into LLDPE (Linear Low Density Polyethylene) masterbatch.

FIG. 7 is a chart showing the haze of 7 μm and 3 μm cullet samples compounded into LLDPE (Linear Low Density Polyethylene) masterbatch.

FIG. 9 is a chart showing the clarity of 7 μm and 3 μm cullet samples compounded into LLDPE (Linear Low Density Polyethylene) masterbatch.

### DETAILED DESCRIPTION OF THE INVENTION

As stated above, the present invention, in a broad aspect, relates to a particulate glass cullet which has a particle size distribution such that the d₅₀ is less than 7 μm which has a brightness of at least 80%.

In another broad product aspect, the invention relates to a particulate glass cullet which has a particle size distribution such that the d₅₀ is less than 4 μm and which has a brightness of at least 80%.

In a further broad aspect, the invention relates to a particulate glass cullet which has a particle size distribution such that the d₅₀ is less than 3 μm and which has a brightness of at least 80%.

The term “cullet” used herein refers to raw glass, broken glass from a cooled melt or scrap glass intended for recycling, and is generally plant generated or recycled from the market place. Included is any type of broken refuse glass, such as but not limited to container glass (e.g. recyclable glass jars or bottles), of all colours, uncoloured glass, tinted or untinted plate glass (e.g. window panes), ceramic glass (e.g. coffee mugs), flint glass and mixtures thereof. Derivatives of cullet are also included within the definition of this term, including remelted cullet and the like.

The cullet used in the present invention may be a silica glass cullet, for example a soda-lime glass cullet. Soda-lime cullet is the most common commercial glass and generally the least expensive to produce. Soda-lime glass is used primarily for bottles, jars and window glass and typically comprises from about 60-75 wt % silica, from 12 to 18 wt % soda and from 5 to 12 wt % lime. Typically, the refractive index of this material is of the order of 1.45 to 1.55.

These glasses may comprise other metal oxides such as alkali oxides (e.g. K₂O), alkali earth oxides (e.g. MgO and BaO), transition metal oxides (e.g. Fe₂O₃, TiO₂) and alumina (Al₂O₃).

The cullet utilised in the present invention will preferably have a boron oxide content of less than 5 wt. %. In container glass the alumina content is generally greater than 0.5 wt. %, and the MgO content is generally less than 2. In plate glass the alumina content is generally less than 0.5 wt. % and the MgO content is generally greater than 2 wt. %. The crystalline silica content of the cullet will typically be very low, such as less than 0.5 wt % for example.

The value of d₅₀ for the fine particulate glass cullet according to one aspect of the invention is less than 7 μm. The d₅₀ may, for example, be less than 3 μm and typically greater than 0.25 μm, such as for example greater than 0.5 μm. The d₅₀ may, for example, be less than 2.5 μm, and may be greater than 1 μm. In embodiments of the invention, the d₅₀ may be less than 2 μm, less than 1.5 μm, less than 1.2 μm, less than 1.1 μm, or less than 1 μm.

The top cut (also referred to as the d₉₀) of the finely ground cullet is preferably less than 10 μm, for example less than 7.5 μm, for example less than 5 μm, for example less than 3 μm. Fines content, that is the amount of particles smaller than 0.25 μm, is typically less than about 10% by weight.

The term “d₅₀” used herein refers to the particle size value less than which there are 50% by weight of the particles. The term d₉₀ is the particle size value less than which there are 90% by weight of the particles.

All particle size values pertaining to the fine particulate cullet are specified as equivalent spherical diameters, and are measured by the well known conventional method employed in the art of sedimentation of the particles in a fully dispersed state in an aqueous medium using a SEDIGRAPH 5100 machine as supplied by Micromeritics Corporation, USA, or by other methods which give essentially the same result.

The particulate cullet may have a surface area, as measured using the BET nitrogen adsorption method, of less than about 20 m²/g, such as less than about 6 m²/g and preferably greater than about 0.25 m²/g, such as greater than about 1 m²/g, or greater than about 3 m²/g.

The particulate cullet may have an oil absorption greater ranging from about 10 g/100 g to about 100 g/100 g, such as for example ranging from 20 g/100 g to about 60 g/100 g, greater than about 30 g/100 g, or greater than about 40 g/100 g. Oil absorption may be measured in accordance with ISO 787 Part 5.

The value of the brightness of the particulate glass cullet according to one aspect of the invention will be greater than 80%. In embodiments of the invention, the brightness may be greater than 81%, greater than 82%, greater than 83%, greater than 84%, greater than 85%, greater than 86%, greater than 87%, greater than 88% greater than 89%, greater than 90%, greater than 91%, or greater than 92%.

According to another aspect of the invention, the glass cullet will have a d₅₀ of less than 4 μm and a brightness greater than 80%. In embodiments of this aspect of the invention, the brightness may be greater than 81%, greater than 82%, greater than 83%, greater than 84%, greater than 85%, greater than 86%, greater than 87%, greater than 88% greater than 89%, greater than 90%, greater than 91%, greater than 92%, or greater than 93%.

For the purpose of the present application “brightness” is defined as the percentage of light reflected by a body compared to that reflected by a perfectly reflecting diffuser measured at a nominal wavelength of 457 nm with a Datacolour Elrepho or similar instrument such as the Carl Zeiss photoelectric reflection photometer. Yellowness is the difference between the percentage of light reflected by a body compared to that reflected by a perfectly reflecting diffuser measured at a nominal wavelength of 571 nm and the brightness value described above. Details of procedures for measuring brightness are set out in the appendix below.

The value of the tint (b* value) of the particulate glass cullet according to the product aspects of the invention is less than about 1.5, but typically greater than about 0.10. In embodiments of the invention, the tint may be less than about 1.3, less than about 1.2, less than about 1.1, less than about 1.0.

According to one aspect of the present invention, the particulate cullet is prepared by a process in which a coarse cullet is ground to the desired particle size distribution having a d₅₀ of less than 7 μm and recovering a particulate product having a brightness greater than 80%. In an embodiment of the invention, the coarse cullet is ground to the desired particle size distribution having a d₅₀ of less than 3 μm. In further embodiments of the invention, the coarse cullet comprises a silica glass, for example a soda-lime cullet.

According to another aspect of the present invention, the particulate cullet is prepared by a process in which a coarse cullet is ground to the desired particle size distribution having a d₅₀ of less than 4 μm and recovering a particulate product having a brightness greater than 80%.

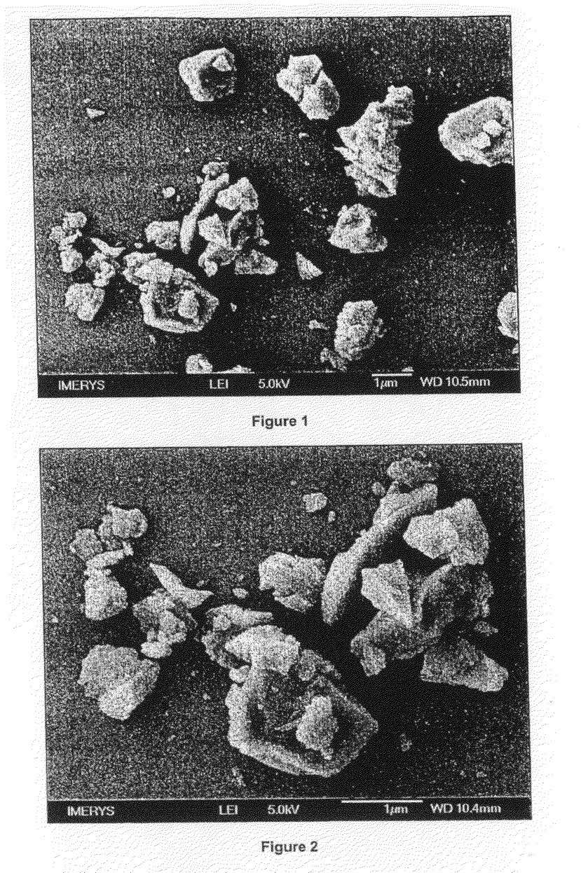

Any suitable known grinding procedure may be employed. Finely ground cullet obtained in this way has a fractured morphology as illustrated in FIGS. 1 and 2, and is characterized in that each particle has a series of randomly disposed, generally flat, cleavage surfaces.

In an embodiment of the invention, the final grinding step to the desired final particle size distribution is an attrition grinding stage.

The attrition grinding is preferably wet attrition grinding or media attrition grinding. The attrition grinding is preferably carried out in the presence of a suitable particulate grinding medium. The particulate grinding medium may be of a natural or a synthetic material. The grinding medium may comprise balls, beads or pellets of any hard mineral, ceramic or metallic material; such materials may include, for example, alumina, zirconia, zirconium, silicate, aluminium silicate or the mullite-rich material which is produced by calcining kaolinitic clay at a temperature in the range of from 1300° C. to 1800° C. For example, in some embodiments a Carbolite™ grinding media is preferred. Alternatively, particles of natural sand of a suitable particle size may be used. Generally, the type of, and particle size of, grinding medium to be selected for use in the invention may be dependent on the properties, such as, e.g. the particle size and the chemical composition of the feed of cullet to be ground.

Alternatively, attrition grinding can be performed autogenously without the presence of grinding media. In autogenous grinding, the raw material to be ground acts as the grinding media. Autogenous mills are available for both wet and dry grinding.

In the case of wet attrition grinding stage, the coarse cullet is preferably ground in an aqueous suspension in the presence of a grinding medium. In such a suspension, the coarse cullet may preferably be present in an amount of from 5% to 85% by weight of the suspension; more preferably in an amount of from 20% to 80% by weight of the suspension. Most preferably, the cullet may be present in an amount of about 30% to 75% by weight of the suspension.

The energy input in a typical wet attrition grinding process to obtain the desired particulate soda-lime glass cullet according to the present invention may typically be equal or greater than about 110 kWht⁻¹. The upper limit of energy input is generally difficult to specify, as the particle size will generally continue to reduce, albeit progressively more slowly, as the energy input is increased. Generally speaking, it should not be necessary for the energy input to exceed about 2000 kWht⁻¹, in order to produce useful fine particulate soda-lime cullet according to the present invention. Preferably, the final energy input should not exceed about 350 kWht⁻¹. Aliquots of slurry may be withdrawn at, for example, 110, 190 and 260 kWht⁻¹ for analysis

The suspension of solid material to be ground may be of a relatively high viscosity, in which case a suitable dispersing agent may preferably be added to the suspension prior to comminution by the method of the invention. The dispersing agent may be, for example, a water soluble condensed phosphate, a water soluble salt of a polysilicic acid or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry particulate solid material. The suspension may suitably be ground at a temperature in the range of from 4° C. to 100° C.

The grinding is continued until the desired particle diameter is achieved, after which the particulate material may be dried. Drying can be accomplished via use of spray driers, flash dryers, drum dryers, shelf or hearth dryers, freeze driers and drying mills, or some combination thereof.

The final attrition grinding may be preceded by a dry grinding step in which a coarse cullet is dry ground to an intermediate particle size greater than the final desired particle size. For example, in this preliminary coarse grinding step, the cullet may be ground such that it has a particle size distribution in respect of which the d₅₀ is less than about 20 μm. This dry, coarse grinding step may, for example, be carried out by dry ball-milling with a ceramic grinding media. Alternatively, grinding may be by high-compression roller, fluid energy mill (also known as jet mill) or hammer mill.

The finding that the raw cullet can be ground down to such fine particle size using wet grinding is unexpected. Glass is an amorphous material, and most of the size reduction during grinding occurs due to fracturing. As the material is ground to very small sizes, grinding becomes difficult as the number and size of the imperfections usually responsible for initiating fracturing decreases. Conventionally, it has been thought very difficult to reduce the particle size of glass by grinding when approaching the size of particle of interest in the present application. However, it has been found that it is possible to produce fine particulate cullet having good light scattering properties and thus a high brightness value, by grinding raw cullet.

The coarse material for the dry grinding step may itself be provided by crushing a raw soda-lime cullet using well known procedures. For example, crushing may be performed using jaw-crushing, for example to reduce the size of the glass fragments to less than about 2 mm.

Either before, or at some stage of, the crushing and grinding process, the cullet is preferably washed free of fine debris which might otherwise contribute to poor brightness and tint. Typically, this washing is carried out on the shards of raw cullet using a washing medium comprising water. The washing step may comprise cleaning the shards of raw cullet with a solvent, such as an organic solvent, an acid, a base, or the like.

A number of additional beneficiation steps may be used to improve brightness and tint. For example, during the crushing or grinding process, the glass cullet may be subjected to bleaching, leaching, magnetic separation, classification, froth flotation, and the like.

As discussed above, care must be taken to avoid contact with metallic equipment during the grinding stage. For this reason, attrition grinding should preferable be carried out in a non-metallic vessel, such as a polyurethane lined pot, using non-metallic impellers, such as polyurethane impellers.

The fine, particulate cullet material of the invention may be used as a filler or functional additive for polymer compositions, including thermosetting and thermoplastic polymer compositions. For example, the particulate material can be added to improve abrasion resistance, as an antiblock, or for enhancing the mechanical and thermal properties of polymer compositions (e.g. polypropylene). In general, the particulate material of the invention can be used in applications in which silica is commonly used. For example, in compositions comprising polyethylene or polypropylene, silicone sealants and rubbers, nylon, and natural and SBR rubbers (a synthetic copolymer of styrene and butadiene). The particulate material may also be used in coating applications, such as in paint (for example polyester based industrial paints), varnish, clear coat or gel coat applications. Where a clear glass cullet is used, the filler/functional additive has the advantage that it is transparent. Thus, the particulate cullet material of the invention may be used as an additive in automotive clear coats to provide a specific property to the coat. It is also non-conductive and so can be added to electrically insulating polymer materials, such as sealants, adhesives and mastics.

The material of the invention may be used in cosmetic applications, pharmaceutical compositions, and in dental applications, for example as a dental filler or abrasive in dental formulations.

The fine particulate material of the invention may also be used in compositions as a rheology modifier.

When used as a filler material, the particulate cullet of the invention may be used at loadings typical in the art, ranging for example from about 500 ppm to about 90 wt %, and may be incorporated in a manner known per se.

The particulate cullet may also be used in abrasive compositions, such as for example dental abrasive compositions.

The invention will now be illustrated, by reference to the following non-limiting examples.

### EXAMPLES

### Example 1

In this example, recycled glass samples were used as follows:

A A ground glass

B An untinted plate glass

C A recycled clear glass (container glass)

D A recycled clear glass

E A recycled mixed colour glass

F A recycled green glass (container glass)

G A recycled clear glass

A mineralogical analysis of coarse ground samples of these materials was carried out using X-ray powder diffraction. The results are shown in Table 1 below.

TABLE 1

| Sample | Quartz (wt. %) | Cristobalite (wt. %) | Amorphous (wt. %) |
|---|---|---|---|
| A | 0 | 0 | 100 |
| B | 0 | 0 | 100 |
| C | 0 | 0 | 100 |
| D | 0 | 0 | 100 |
| E | 0 | 0 | 100 |
| F | <0.5 | 0 | 100 |
| G | <0.5 | 0 | 100 |

A chemical analysis of the samples was undertaken using X-ray Fluorescence Spectroscopy. The results are shown in the Table 2 below.

TABLE 2

| | Al₂O₃ | SiO₂ | Fe₂O₃ | TiO₂ | K₂O | CaO | MgO | Na₂O | L.O.I. |
|---|---|---|---|---|---|---|---|---|---|
| Sample | wt. % | wt. % | wt. % | wt. % | wt. % | wt. % | wt. % | wt. % | wt. % |
| A | 0.20 | 70.1 | 0.18 | 0.06 | 0.06 | 8.13 | 4.62 | 16.57 | 0.09 |
| B | 0.10 | 70.0 | 0.13 | 0.01 | 0.03 | 8.35 | 4.63 | 16.65 | 0.15 |
| C | 1.3 | 70.1 | 0.09 | 0.03 | 0.52 | 10.24 | 1.55 | 15.78 | 0.37 |
| D | 1.4 | 69.4 | 0.09 | 0.06 | 0.44 | 10.91 | 0.71 | 15.97 | 1.05 |
| E | 1.4 | 70.9 | 0.11 | 0.04 | 0.5 | 10.1 | 0.78 | 16.2 | 0.02 |
| F | 1.7 | 70.0 | 0.33 | 0.06 | 0.67 | 10.43 | 1.29 | 15.42 | 0.14 |
| G | 1.4 | 70.6 | 0.12 | 0.07 | 0.54 | 10.14 | 1.49 | 15.52 | 0.18 |

Cullet samples were initially jaw crushed using an agate pulverising mill to reduce the particle size to nominally less than 100 μm, typically giving ˜30 wt. % smaller than 10 μm. Each sample was then fine ground by wet attrition using carbolite grinding media (grade 16/10) in a stirred, polyurethane pot, with a polyurethane coated impeller. Typically 500 g of the coarse ground material was ground at ˜60 wt. % solids with a dispersant dose of 1.1 wt. % sodium polyacrylate and a final energy input of 350 kWh t⁻¹. Aliquots of slurry were periodically withdrawn at 110, 190 and 260 kWh t⁻¹. Optical properties for the wet attrition ground samples are shown in Table 3 below. Particle size data for the wet attrition ground samples are shown in Table 4.

TABLE 3

| | Energy Input | Brightness | | |
|---|---|---|---|---|
| Sample Ref. | (kWh t⁻¹) | (%) | L* | B* (tint) |
| B | 110 | 90.7 | 96.6 | 0.68 |
| | 190 | 92.0 | 97.1 | 0.53 |
| | 260 | 91.5 | 96.9 | 0.65 |
| | 350 | 92.9 | 97.3 | 0.34 |
| C | 110 | 90.4 | 96.5 | 0.6 |
| | 190 | 91.7 | 96.9 | 0.31 |
| | 260 | 92.2 | 97.0 | 0.25 |
| | 350 | 92.6 | 97.1 | 0.14 |
| E | 110 | 88.8 | 96.1 | 1.1 |
| | 190 | 89.7 | 96.3 | 0.9 |
| | 260 | 90.5 | 96.6 | 0.73 |
| | 350 | 91.1 | 96.7 | 0.6 |
| F | 110 | 85.0 | 95.4 | 2.58 |
| | 190 | 83.0 | 94.9 | 3.19 |
| | 260 | 85.3 | 95.2 | 2.13 |
| | 350 | 86.2 | 95.5 | 1.95 |
| G (unwashed) | 110 | 84.3 | 94.6 | 1.89 |
| | 190 | 86.6 | 95.3 | 1.5 |
| | 260 | 87.7 | 95.7 | 1.26 |
| | 350 | 88.5 | 95.9 | 1.09 |
| G (water washed) | 110 | 91.6 | 97.2 | 1.13 |
| | 190 | 92.8 | 97.6 | 0.82 |
| | 260 | 93.0 | 97.6 | 0.77 |
| | 350 | 92.6 | 97.4 | 0.72 |

TABLE 4

| | Energy | | | | | | | | d₁₀ | d₅₀ | d₉₀ |
|---|---|---|---|---|---|---|---|---|---|---|---|
| Sample | (kWh/t) | >10 μm | >5 μm | <2 μm | <1 μm | <.5 μm | <0.25 μm | <0.1 μm | (μm) | (μm) | (μm) |
| B | 110 | 9.3 | 38.4 | 25.4 | 11.4 | 5.7 | 3.3 | 2.4 | 0.9 | 3.9 | 9.8 |
| | 190 | 1.1 | 14.6 | 39.6 | 18.4 | 8.8 | 4.4 | 2.1 | 0.6 | 2.5 | 5.6 |
| | 260 | 0.1 | 4.8 | 58.0 | 31.2 | 15.0 | 8.4 | 6.4 | 0.3 | 1.6 | 4.1 |
| | 350 | 0.8 | 2.1 | 73.0 | 41.6 | 24.0 | 18.4 | 15.9 | NA | 1.2 | 3.0 |
| C | 110 | 10.7 | 40.7 | 25.1 | 11.5 | 5.5 | 3.8 | 2.9 | 0.8 | 4.1 | 10.3 |
| | 190 | 2.2 | 21.0 | 35.5 | 16.4 | 7.8 | 4.5 | 3.2 | 0.6 | 2.9 | 6.5 |
| | 260 | 0.9 | 7.6 | 48.5 | 23.1 | 10.1 | 5.1 | 2.6 | 0.5 | 2.1 | 4.6 |
| | 350 | 0.6 | 2.0 | 64.4 | 32.4 | 14.1 | 7.1 | 5.1 | 0.4 | 1.5 | 3.4 |
| E | 110 | 3.7 | 23.7 | 34.9 | 16.8 | 7.4 | 4.5 | 4.9 | 0.7 | 2.9 | 7.2 |
| | 190 | 2.4 | 13.3 | 42.9 | 21.4 | 9.0 | 5.7 | 4.7 | 0.5 | 2.4 | 5.5 |
| | 260 | 0.3 | 4.1 | 57.9 | 28.9 | 13.2 | 6.3 | 5.2 | 0.4 | 1.7 | 3.9 |
| | 350 | 0.3 | 1.3 | 71.1 | 35.7 | 15.2 | 7.0 | 5.4 | 0.4 | 1.4 | 3.0 |
| F | 110 | — | — | — | — | — | — | — | — | — | — |
| | 190 | 1.6 | 10.9 | 44.0 | 18.3 | 7.6 | 4.2 | 1.2 | 0.6 | 2.3 | 5.2 |
| | 260 | 1.5 | 5.9 | 56.9 | 27.6 | 11.2 | 5.4 | 0 | 0.5 | 1.7 | 4.2 |
| | 350 | 0.9 | 3.1 | 79.1 | 47.7 | 20.6 | 9.9 | 4.7 | 0.3 | 1.0 | 2.9 |
| G (un- | 110 | 12.5 | 40.6 | 22.6 | 9.5 | 4.0 | 2.4 | 2.1 | 1.0 | 4.1 | 11.1 |
| washed) | 190 | 3.5 | 21.5 | 35.3 | 16.0 | 6.2 | 4.1 | 3.8 | 0.7 | 2.9 | 6.7 |
| | 260 | 1.2 | 7.8 | 55.7 | 26.6 | 10.7 | 5.4 | 4.3 | 0.5 | 1.8 | 4.6 |
| | 350 | 1.4 | 4.6 | 68.2 | 40.1 | 17.5 | 9.1 | 6.3 | 0.3 | 1.3 | 3.8 |
| G | 110 | 13.2 | 41.5 | 23.2 | 10.8 | 5.0 | 2.5 | 1.9 | 0.9 | 4.2 | 11.4 |
| (water | 190 | 4.3 | 20.2 | 34.6 | 15.5 | 6.1 | 3.3 | 0.1 | 0.7 | 2.9 | 6.7 |
| washed) | 260 | 2.0 | 6.9 | 54.5 | 27.3 | 11.2 | 4.9 | 2.0 | 0.5 | 1.8 | 4.4 |
| | 350 | 1.2 | 3.4 | 60.9 | 30.0 | 12.0 | 5.3 | 2.4 | 0.4 | 1.6 | 3.7 |

The results show that the process of the present invention consistently gives products with a particle size range of 1-3 um, high brightness values (91-93%) and low tint (b values as low as 0.14, but typically ˜0.7). This range of particle size products has been achieved with a maximum energy input of 350 kWh t⁻¹.

### Example 2

Three samples of glass cullet (recycled clear container glass) were finely ground to d₅₀ values of about 7 μm, 3 μm and 1.5 μm respectively, and subjected to a chemical analysis and a particle size analysis. Equivalent data is also provided for a number of commercially available antiblocking agents; Celite 263LD (made from calcined diatomaceous earth and supplied by ‘World Minerals’), Sylobloc 45 (an amorphous silica manufacture by ‘Grace Division’), P200R (a calcined clay manufactured by ‘Imerys Minerals Ltd’) and Polybloc (a talc anitblock supplied by ‘Speciality Minerals Inc.’).

The chemical analysis of the samples was undertaken using X-ray Fluorescence Spectroscopy. The results are shown in the Table 5 below. The glass cullet has a typical composition for soda-lime glass.

TABLE 5

| | Al₂O₃ | SiO₂ | K₂O | Fe₂O₃ | TiO₂ | CaO | MgO | Na₂O | |
|---|---|---|---|---|---|---|---|---|---|
| Sample | wt. % | wt. % | wt. % | wt. % | wt. % | wt. % | wt. % | wt. % | L.O.I. |
| 7 μm Cullet | 1.7 | 71.0 | 0.56 | 0.12 | 0.05 | 10.65 | 1.53 | 14.24 | 0.18 |
| 3 μm Cullet | 1.6 | 70.8 | 0.54 | 0.11 | 0.04 | 10.36 | 1.52 | 14.81 | 0.18 |
| 1.5 μm Cullet | 1.5 | 70.7 | 0.53 | 0.12 | 0.06 | 10.29 | 1.49 | 15.14 | 0.18 |
| Calcined DE | 0.5 | 92.2 | 0.08 | 0.25 | 0.05 | 5.25 | 0.39 | 1.08 | 0.24 |
| Amorphous Silica | 0.2 | 94.0 | <0.01 | 0.02 | 0.03 | 0.04 | 0.03 | 0.15 | 5.59 |
| Calcined Clay | 41.0 | 55.5 | 1.95 | 0.65 | 0.06 | 0.05 | 0.26 | 0.15 | 0.41 |
| Talc | 7.2 | 72.3 | 2.85 | 0.884 | 0.01 | 0.88 | 11.3 | 1.16 | 2.98 |

Particle size (measured by CILAS), surface area and Hegmann dispersability data for the ground samples are shown in Table 6. Sylobloc has an exceptionally high surface area, and it may be that an aggregate size was measured and so the fundamental particle size is much smaller than that measured by CILAS.

TABLE 6

| | | | | | | d₉₀ | d₅₀ | SA^{a)} | Hegman |
|---|---|---|---|---|---|---|---|---|---|
| Sample | % <10 μm | % <5 μm | % <2 μm | % <1 μm | % <0.5 μm | (μm) | (μm) | m²/g | (μm) |
| 7 μm Cullet | 26.5 | 33.8 | 12.4 | 3.6 | 0.8 | 13.1 | 6.9 | 0.4 | 58 |
| 3 μm Cullet | 91.3 | 71.1 | 33.7 | 11.3 | 3.2 | 9.8 | 3.0 | 3.2 | 96 |
| 1.5 μm Cullet | 99.6 | 94.6 | 62.7 | 20.8 | 3.8 | 3.7 | 1.6 | 5.7 | 130 |
| Calcined DE | 37.7 | 16.6 | 6.6 | 2.2 | 0.3 | | 12.5 | 1.6 | 45 |
| Amorphous Silica | 99.8 | 60.0 | 8.1 | 0.2 | 0.2 | | 4.5 | 398 | 10 |
| Calcined Clay | 91.6 | 71.3 | 33.8 | 12.5 | 3.7 | | 3.0 | 8.3 | 40 |
| Talc | 88.2 | 62.7 | 27.9 | 10.5 | 3.2 | | 3.8 | 6.9 | 25 |

^{a)}surface area

Optical properties of the ground samples are shown in Table 7. The 3 μm d₅₀ and 1.5 μm d₅₀ cullet samples are as least as bright (L* value) as the commercial antiblock samples. The yellowness of each of the cullet samples is better than the commercial anitblock samples. The refractive index of the cullet is very similar to that of polyethylene, indicating that the cullet may give advantageous in reducing haze generated by scattering in a polymer comprising the cullet.

TABLE 7

| | Powder Brightness | | | | |
|---|---|---|---|---|---|
| | Brightness | | | | Refr. |
| Sample | (VIO) | L* | a* | b* | Index |
| 7 μm Cullet | 77.6 | 90.9 | −0.07 | 0.48 | 1.515 |
| 3 μm Cullet | 86.8 | 94.9 | −0.06 | 0.37 | 1.515 |
| 1.5 μm Cullet | 89.4 | 95.9 | −0.09 | 0.38 | 1.515 |
| Calcined DE | 84.7 | 94.3 | −0.05 | 1.06 | 1.49 |
| Amorphous Silica | 85.2 | 95.2 | −0.46 | 2.37 | 1.47 |
| Calcined Clay | 88.9 | 96.9 | −0.10 | 2.70 | 1.52 |
| Talc | 87.6 | 95.7 | −0.14 | 1.37 | 1.55 |

The three ground cullet samples were subjected to three different surface treatments. These were applied during de-aggregation (300 s on a laboratory scale mill). The results are shown in Table 8.

TABLE 8

| | d₉₀ | d₉₀ |
|---|---|---|
| Treatment | 0 days | 2 days |
| 1.5 um Cullet - untreated - exposed to air | 3.75 | 18.1 |
| 1.5 um Cullet - untreated - stored in closed container | 3.75 | 18.1 |
| 1.5 um Cullet - untreated - stored in vacuum oven | 3.75 | 17.8 |
| @50° C. | | |
| 1.5 um Cullet - 0.5 wt % Amino-silane - exposed to air | 3.58 | 3.58 |
| 1.5 um Cullet - 1.0 wt % Amino-silane - exposed to air | 3.80 | 3.94 |
| 1.5 um Cullet - 0.5 wt % AMP95 - exposed to air | 3.75 | 3.75 |
| 1.5 um Cullet - 1.0 wt % AMP95 - exposed to air | 3.92 | 3.86 |
| 1.5 um Cullet - 1.0 wt % TEA - exposed to air | 3.86 | 3.85 |

The 7 μm and 3 μm cullet samples were compounded into LLDPE (Linear Low Density Polyethylene) masterbatch (30 μm LLDPE film). Formulation details were as follows:
Polymer: 90:10 blend of Innovex LL6208F and Exxon Mobil LD100BW
Slip aid: Erucamide at 1:2 ratio with fillers
Process aid: 100 ppm AMF 705
(Slip and process aids added in 5 wt. % masterbatches in LLDPE)
1000, 2000 and 3000 ppm of antiblock comprising 7 μm cullet (Antiblock A) and 3 μm cullet (Antiblock B)

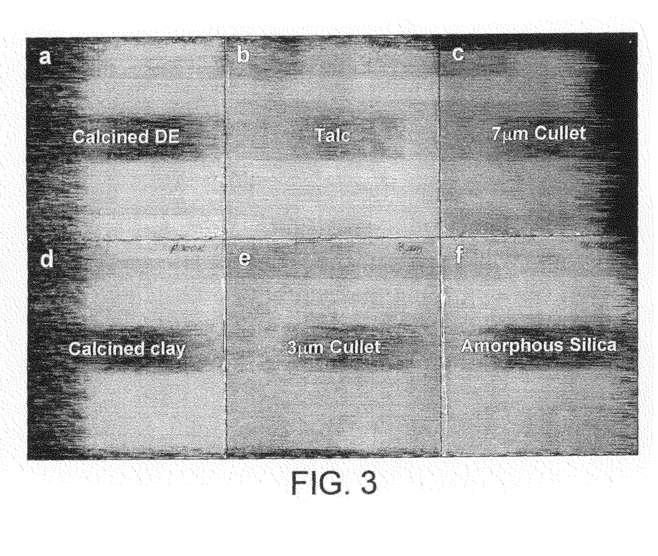

Film processing details were as follows:
Film blown using a Collin 180/30 extruder, with a 60 mm die diameter and 0.8 mm die gap, at 30 μm gauge
Temperature profile: 240° C. at the die: 240, 240 240, 240, 235, 220, 190° C. in the barrel
Screw speed: 56 rpm
Blow Up Ratio 1:2.5
Haul off: 10 m min⁻¹
Layflat: 225 mm
Samples conditioned at 20° C. 50% RH for minimum of 48 hours before testing
   Colour data for the masterbatch (MB) plaques are given in Table 9. Photographs of the filled plastics are shown in FIGS. 3a to 3f.

TABLE 9

| | Filler | Colour of MB plaques | | |
|---|---|---|---|---|
| Sample | Load(wt %) | L* | a* | b* |
| 7 μm Cullet | 10.0 | 71.53 | −1.22 | 6.42 |
| 3 μm Cullet | 11.0 | 73.47 | −0.42 | 13.42 |
| Calcined Clay | 10.2 | 74.01 | 2.76 | 12.6 |
| Calcined DE | 9.9 | 77.05 | −0.19 | 8.53 |
| Talc | 10.5 | 73.73 | 0.28 | 8.28 |
| Amorphous Silica | 11.2 | 75.71 | 2.86 | 17.16 |

Both cullet samples have similar colour performance in LLDPE masterbatch to the commercial materials. The 7 μm cullet's low yellowness is an important asset when selling anitblock masterbatch, as it reduces the “dirty” appearance of the film once reeled.

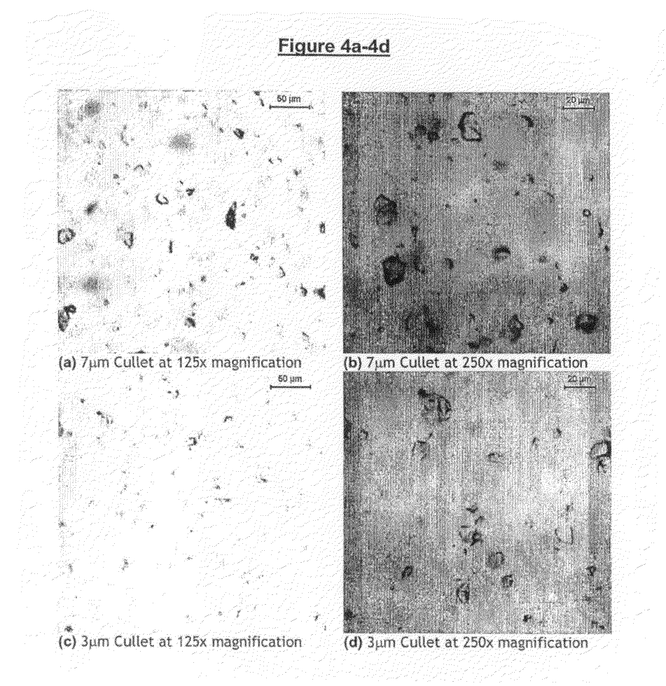

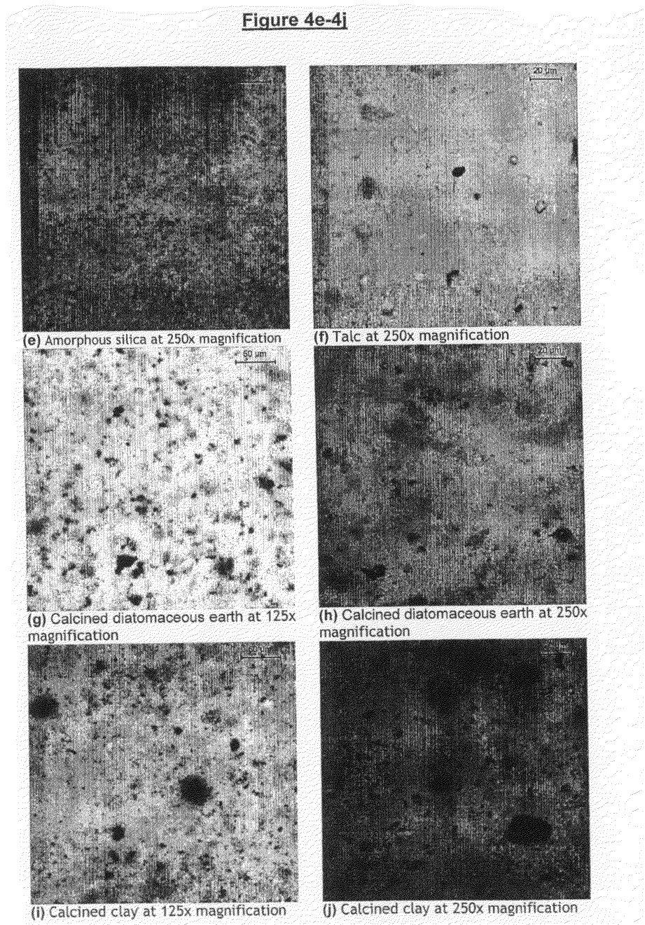

Dispersion of the cullet/masterbatch samples were analysed under transmitted light under alight microscope. In each case, a small amount of the cullet/masterbatch was pressed between two sheets of Melinex film in a heated hydraulic press to form a transparent but relatively thick film (approximately 100 μm). The pictures are shown in FIG. 4.

Both the 7 μm and 3 μm cullet samples show good dispersion in LLDPE masterbatch. Some difficulty was experienced in obtaining clear images of the cullets resulting from the close refractive index match with the polymer. This however should result in good low haze performance in blown film.

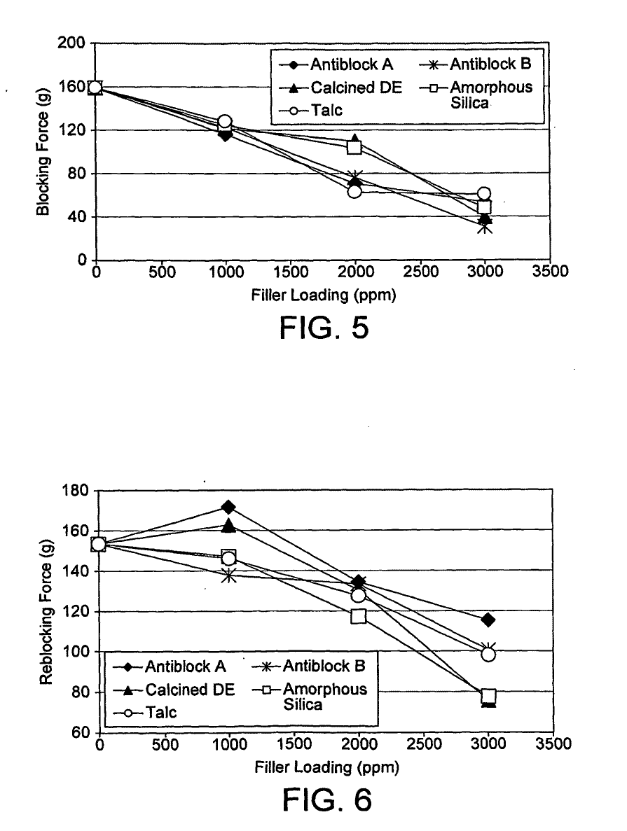

The blocking force for each of the samples are shown in FIG. 5, and was determined according to ASTM D3354-89. FIG. 5 illustrates that the two novel antiblock materials provide equivalent antiblocking performance to the commercial materials at the tested loading levels.

The reblocking force for each of the samples are shown in FIG. 6, and was determined according to ASTM D3354-89. FIG. 6 illustrates that the novel antiblock material “Antiblock B” provides equivalent reblocking performance to the commercial materials tested at all of the loading levels presented here. The novel antiblock material “Antiblock A” provides slightly poorer reblocking performance to some of the commercial materials tested, but similar performance to the Celite 263LD sample, at the tested loading levels.

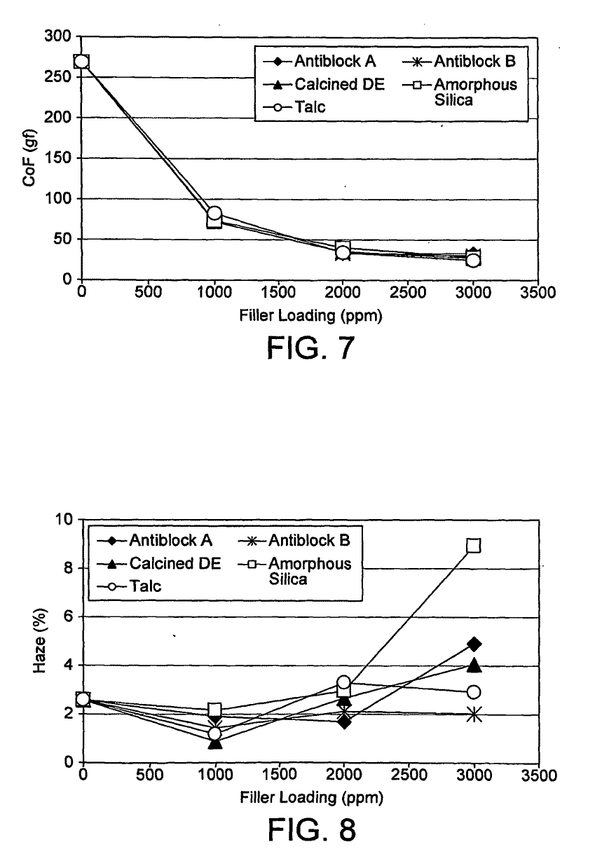

The film-to-film coefficient of friction of each of the samples are shown in FIG. 7, and was determined according to ASTM D1894-90. FIG. 7 illustrates that the two novel antiblock materials provide comparable Dynamic Coefficient of Friction performance to the commercial materials tested at the tested loading levels.

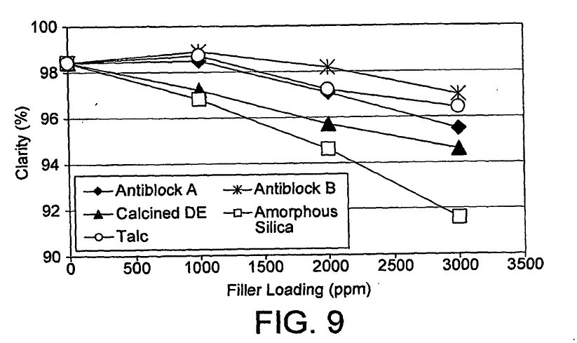

The haze and clarity of each of the samples are shown in FIG. 8 and FIG. 9 respectively. FIG. 6 illustrates that both novel antiblock materials provide comparable haze performance to the commercial materials at load levels up to 2000 ppm. The novel antiblock material “Antiblock B” provides better Haze performance than the commercial materials at load levels in excess of 2000 ppm. The novel antiblock material “Antiblock A” provides similar Haze performance to the commercial materials at load levels up to 2000 ppm, and that both provide better performance than the Sylobloc 45 sample at load levels in excess of 2000 ppm.

FIG. 9 illustrates that both novel antiblock materials provide equivalent clarity performance to Polybloc talc, and better clarity performance than the other commercial materials, at tested load levels. Both novel antiblock materials provide better performance than the Sylobloc 45 sample at load levels up to 3000 ppm.

The present invention has been described broadly and without limitation to specific embodiments. Variations and modifications as will be readily apparent to those of ordinary skill on this art are intended to be included within the scope of this application and subsequent patent(s).

### APPENDIX—‘BRIGHTNESS’ TEST METHOD

### Definitions

Brightness is the percentage of light reflected by a body compared to that reflected by a perfectly reflecting diffuser measured at a nominal wavelength of 457 nm with a Datacolor Elrepho or similar instrument such as the Carl Zeiss Photoelectric Reflection Photometer (Elrepho).

Yellowness is the difference between the percentage of the light reflected by a body compared to that reflected by a perfectly reflecting diffuser measured at a nominal wavelength of 571 nm and the brightness defined above.

### Scope

A test surface is produced by pulverising a dried material to disperse it completely then compressing it under fixed conditions to form a powder tablet. The reflectance values of this tablet are measured at two wavelengths in the visible spectrum. Additional reflectance values may be measured at other wavelengths when required and can be used to calculate the tristimulus values or other functions. The spectrophotometer incorporates a gloss shield and the measurements are made with the ultraviolet component excluded.

### Standards

The primary standard adopted in this method is an ISO level 2 reflectance standard supplied and calibrated by Physikalisch-Technische Bundesanstalt (P.T.B.) Germany. (ISO appointed primary calibration laboratory.).

A ‘working standard’ is used to calibrate the photometer for routine brightness measurements. This may be a ceramic tile which has been calibrated previously against the current level 2 standard.

### Apparatus

Elrepho Datacolor, or Carl Zeiss Photoelectric Reflection Photometer (Elrepho) fitted with two tungsten lamps, a gloss shield and a range of filters, including one at a nominal setting of 457 nm and one at a nominal setting of 571 nm.

Drying oven, forced circulation type, capable of maintaining a temperature of 80° C. to within 5° C.

Pulveriser and sample bowls.

Tablet forming equipment, comprising of a cylinder, piston, press, measuring cup, forming rings and ring holder. The press is designed to exert a pressure of 1.2 kg cm⁻² upon the tablet surface.

Plate glass, approximately 100 mm×80 mm×5 mm. Metal polish (for cleaning the plate glass).

Balance capable of weighing 20 g to within 0.1 g.

Miscellaneous: sample dishes, small brush, duster, palette knife, sealed container.

### Preparation of Powder Tablet

20 g of the sample is transferred to a sample dish and placed in the oven for between 15 and 30 minutes or until dry. Dryness is denoted by the absence of condensation on a piece of cool plate glass when it is placed in close proximity to the surface of the sample which has just been removed from the oven.

The dish is removed from the oven and allowed to cool.

10 g of test sample is pulverise for 30 seconds (if a pulveriser is not available a substitute mill may be used providing it has a rotational shaft speed of at least 20,000 r.p.m). In addition, a series of milling sessions are carried out to determine the conditions that provide maximum dispersion. This state is denoted when the brightness gain after successive millings does not exceed 0.1% reflectance unit.

Transfer the sample from the Pulveriser into an empty dish. Place the tablet-forming ring, numbered side facing downwards, onto the clean glass. Place the cylinder onto the ring.

Measure out approximately 20 ml of test sample using the measuring cup. NOTE: If the bulk density of the material is such that the volume of 10 g of the pulverised test sample is less than 20 ml then use all of it. Pour the sample into the cylinder and level it. Lower the piston gently onto the sample.

Position the glass supporting the piston in such a manner, that when the lever of the press is lowered, the spigot engages the dimple in the centre of the piston. Lower the lever press gently onto the piston and allow the lever to rest there under its own weight for 20 seconds. Do not apply additional pressure. Raise the lever and remove the piston and cylinder. Remove the ring containing the powder tablet.

### Measurement of Brightness and Yellowness

The standard instrument for reflectance is the Datacolor (2000 or 3000). The instrument is PC driven and is programmed to follow the manufacturer's instructions to determine the functions required. These instructions are controlled locally and displayed within the vicinity of the instrument.

Operating instructions for the Zeiss Elrepho are as follows:

1. Select the filter control position 12 and zero the meter.

2. Select filter 457 nm (filter position number 8).

3. Place the working standard into the ring holder and place it on the spring-loaded pedestal. Unlock the pedestal and allow it to present the standard to the measuring aperture.

4. Set the graduated drum to the value assigned to the standard.

5. Balance the indicator with the neutral wedge control operated in conjunction with the sensitivity key.

6. Lower the pedestal, remove the standard from the ring holder, replace it with the test sample and allow the pedestal to present the test sample to the measuring aperture.

7. Balance the indicator by rotating the graduated drum operated in conjunction with the sensitivity key.

8. Record the reading on the graduated drum to within 0.1 reflectance unit. Remove the test sample.

9. Select filter 571 nm (filter position number 3).

10. Repeat 3 to 8. If the subsequent measurement of the working standard deviates by more than 0.1 reflectance unit from the previous measurement, re-calibrate the instrument and repeat the batch of measurements.

11. If reflectance values at other wavelengths are required, select the appropriate filter and repeat 3 to 8 using the appropriate standard value in 4.

### Expression of Results

Brightness is reported as the percentage reflectance of 457 nm (violet) and is reported as read from the instrument. The yellowness is reported as the value obtained when the reflectance at 457 nm is subtracted from the reflectance at 571 nm. Reflectance values at other wavelengths are reported as the percentage reflectance corresponding to the function required.

### Precision

The standard deviation for reflectance measurements is 0.2.

### Equipment Check and Calibration

This is controlled locally and is ISO9001(2000) compliant.

### Equipment Suppliers

Datacolor International, 6 St. George's Court, Dairyhouse Lane, Broadheath, Altrincham, Cheshire, WA14 5UA, England.

1. A particulate glass cutlet having a d₅₀ of less than 7 μm and a brightness greater than 80%.

2. A particulate glass cullet according to claim 1, wherein the cullet comprises a silica glass.

3. A particulate glass cullet according to claim 2, wherein the silica glass cutlet is a soda-lime cullet.

4. A particulate glass cullet according to claim 3, wherein the particulate glass comprises from 60-75 wt % silica, from 12 to 18 wt % soda and from 5 to 12 wt % lime.

5. A particulate glass cullet according to any one of claims 1 to 4, wherein the particulate glass comprises less than 5 wt % boric oxide.

6. A particulate glass cutlet according to any of one claims 1 to 5, wherein the particulate cullet has a d₅₀ of less than 4 μm.

7. A particulate glass cullet according to any of one claims 1 to 5, wherein the particulate cutlet has a d₅₀ of less than 3 μm.

8. A particulate glass cullet according to any of one claims 1 to 5, wherein the particulate cullet has a d₅₀ of less than 2.5 μm.

9. A particulate glass cutlet according to any one of claims 1 to 5, wherein the particulate cullet has a d₅₀ of less than 2 μm.

10. A particulate glass cullet according to any one of claims 1, to 5, wherein the particulate cullet has a d₅₀ of less than 1.5 μm.

11. A particulate glass cullet according to any one of claims 1 to 5, wherein the particulate cullet has a d₅₀ of less than 1.2 μm.

12. A particulate glass cullet according to any one of claims 1-11, wherein the brightness is greater than 81%.

13. A particulate glass cullet according to any one of claims 1-11, wherein the brightness is greater than 82%.

14. A particulate glass cullet according to any one of claims 1-11, wherein the brightness is greater than 83%.

15. A particulate glass cullet according to any one of claims 1-11, wherein the brightness is greater than 84%.

16. A particulate glass cullet according to any one of claims 1-11, wherein the brightness is greater than 85%.

17. A particulate glass cullet according to any one of claims 1-11, wherein the brightness is greater than 86%.

18. A particulate glass cullet according to any one of claims 1-11, wherein the brightness is greater than 87%.

19. A particulate glass cullet according to any one of claims 1-11, wherein the brightness is greater than 88%.

20. A particulate glass cullet according to any one of claims 1-11, wherein the brightness is greater than 89%.

21. A particulate glass cullet according to any one of claims 1-11, wherein the brightness is greater than 90%.

22. A particulate glass cullet according to any one of claims 1-11, wherein the brightness is greater than 91%.

23. A particulate glass cullet according to any one of claims 1-11, wherein the brightness is greater than 92%.

24. A particulate glass cullet according to any one of claims 1-11, wherein the brightness is greater than 93%.

25. A particulate glass cullet according to any one of claims 1-24, wherein the surface area is greater than about 0.25 m² g⁻¹

26. A particulate glass cullet according to any one of claims 1 to 24, wherein the surface area is less than about 20 m²g⁻¹.

27. A particulate glass cullet according to any preceding claim, which has a d₉₀ of less than 10 μm.

28. A particulate soda-lime glass cullet according to any preceding claim, which has a refractive index in the range of from about 1.45 to 1.55.

29. A process for the preparation of particulate glass cullet which comprises grinding a coarse glass cullet to a particle size distribution such that the d₅₀ is smaller than 7 μm, and recovering a particulate product having a brightness greater than 80%.

30. A process according to claim 29, wherein the cullet comprises a silica glass.

31. A process according to claim 30, wherein the silica glass cullet is a soda-lime cullet.

32. A process according to claims 29-31, wherein the coarse cullet is attrition ground to said particle size distribution.

33. The process of claim 32, wherein said attrition grinding is wet attrition grinding.

34. The process of claim 32 or 33, wherein said attrition grinding is conducted in the presence of a grinding media.

35. The process of claim 34, wherein the attrition grinding media is selected from the group consisting of carbolite, alumina silicate, mullite, alumina, zirconia or mixtures thereof.

36. The process of any one of claims 29 to 35, wherein, prior to the attrition grinding, particulate cullet is ground in a dry grinding step to provide the coarse ground cullet material.

37. The process of claim 36, wherein the dry coarse grinding includes grinding in a high-compression roller mill, fluid energy mill, a ball mill, or a hammer mill.

38. The process of claim 36 or 37, wherein the particulate cullet for coarse grinding is provided by crushing raw cullet.

39. The process of any one of claims 29 to 38, wherein the raw cullet is washed prior to grinding, or is washed during or after grinding.

40. The process according to any one of claims 29-38, wherein the coarse glass cullet is ground to a particle size distribution such that the d₅₀ is less than 4 μm.

41. The process according to any one of claims 29-38, wherein the coarse glass cullet is ground to a particle size distribution such that the d₅₀ is less than 3 μm.

42. Use of particulate glass cullet having a d₅₀ less than 7 μm and a brightness of greater than 80% in abrasive compositions.

43. Use of particulate glass cullet having a d₅₀ less than 7 μm and a brightness of greater than 80% in a polymer composition as a filler.

44. Use according to claim 43 as a filler or functional additive in a transparent polymer composition.

45. Use according to claim 43 as an electrically non-conductive filler.

46. Use of particulate glass cullet having a d₅₀ less than 7 μm and a brightness of greater than 80% in a polymer composition as an anti-blocking pigment.

47. Use of particulate glass cullet having a d₅₀ less than 7 μm and a brightness of greater than 80% as a filler in an electrically non-conductive sealant or adhesive composition.

48. Use of particulate glass cullet having a d₅₀ less than 7 μm and a brightness of greater than 80% in a clear coat or gel coat.

49. Use according to any one of claims 42 to 48, wherein the particulate glass cullet has a d₅₀ less than 4 μm.

50. Use according to any one of claims 42 to 48, wherein the particulate glass cullet has a d₅₀ less than 3 μm.

51. A polymer composition comprising the particulate glass according to any one of claims 1-29.

52. A composition according to claim 51 wherein the polymer composition comprises a polymer selected from the group consisting of polyethylene, polypropylene, nylon, natural rubber, SBR rubber, silicone rubber and polyesters.

53. A particulate glass cullet having a d₅₀ less than 7 μm and a brightness greater than 80%, substantially as hereinbefore described with reference to the accompanying examples.

54. A particulate glass cullet having a d₅₀ less than 4 μm and a brightness greater than 80%, substantially as hereinbefore described with reference to the accompanying examples.

55. A particulate glass cullet having a d₅₀ less than 3 μm and a brightness greater than 80%, substantially as hereinbefore described with reference to the accompanying examples.

56. A process for the preparation of particulate glass cullet having a d₅₀ smaller than 7 μm and a brightness greater than 80%, substantially as hereinbefore described with reference to the accompanying examples.

57. A process for the preparation of particulate glass cullet having a d₅₀ smaller than 4 μm and a brightness greater than 80%, substantially as hereinbefore described with reference to the accompanying examples.

58. A process for the preparation of particulate glass cullet having a d₅₀ smaller than 3 μm and a brightness greater than 80%, substantially as hereinbefore described with reference to the accompanying examples.

59. A particulate soda-lime glass cullet having a d₅₀ of less than 7 μm and a brightness greater than 80%.

60. A particulate soda-lime glass cullet having a d₅₀ of less than 4 μm and a brightness greater than 80%.

61. A particulate soda-lime glass cullet having a d₅₀ of less than 3 μm and a brightness greater than 80%.
